(19) United States
(12) Patent Application Publication
(10) Pub. No.: US 2016/0140665 A1
(43) Pub. Date: May 19, 2016

(54) METHOD AND SYSTEM OF IMPROVING THE INTEGRITY OF LOCATION DATA IN RECORDS RESULTING FROM ATM-BASED SINGLE MESSAGE TRANSACTIONS PROCESSED OVER A PAYMENT NETWORK

(71) Applicant: MASTERCARD INTERNATIONAL INCORPORATED, Purchase, NY (US)

(72) Inventors: DIVYAM MAYAWALA, White Plains, NY (US); STEPHEN DANTU, Armonk, NY (US); ROOPA VAIDYA, Elmsford, NY (US); MICHAEL CARDAMONE, New Windsor, NY (US)

(21) Appl. No.: 14/541,656

(22) Filed: Nov. 14, 2014

(51) Int. Cl. G06Q 40/00; G06F 17/30

(52) U.S. Cl. CPC G06Q 40/12; G06F 17/30864; G06F 17/30879; G06Q 20/1085

(57) ABSTRACT

A method and system are provided herein of improving the integrity of location data in records resulting from ATM-based single message transactions processed over a payment network including: electronically storing records on a specialized computing device, the records resulting from ATM-based single message transactions processed over a payment network; geocoding location data in the records to generate geocoded records which are electronically stored on the specialized computing device; extracting at least two details from a first of the geocoded records; and, comparing, using a special purpose database management system, the at least two details with data structures maintained in a special purpose database of ATM-related information generated independently of the records resulting from the ATM-based single message transactions. Advantageously, the subject invention allows for the integrity of the details of the processed transactions to be improved, in reporting to users, to minimize confusion and challenges of fraud.

### FIELD OF INVENTION

This invention relates to a method and system of improving the integrity of location data in records resulting from ATM-based single message transactions processed over a payment network.

### BACKGROUND OF THE INVENTION

Recognizable details of reported automatic teller machine (“ATM”) transactions are critical for minimizing consumer perceived fraudulent or improper transactions. To minimize confusion or the perception of fraud, best available location data of a transacted ATM is helpful in reporting. Reporting details are typically taken from the details of the completed transaction. ATM transactions may be processed over a payment network using single message transaction processing, such as with the MasterCard Debit Switch system. Other single message transaction systems are known, where transactions are processed over a payment network without a user's signature.

For various reasons, the details associated with completed single message transactions processed over a payment network may not be complete and/or not recognizable when reported to users. Such transactions may cause confusion and lead to challenges of the validity of the transactions by the users. Integrity of the reported details is critical to minimizing such challenges.

### SUMMARY OF THE INVENTION

A method and system are provided herein of improving the integrity of location data in records resulting from ATM-based single message transactions processed over a payment network including: electronically storing records on a specialized computing device, the records resulting from ATM-based single message transactions processed over a payment network; geocoding location data in the records to generate geocoded records which are electronically stored on the specialized computing device; extracting at least two details from a first of the geocoded records; and, comparing, using a special purpose database management system, the at least two details with data structures maintained in a special purpose database of ATM-related information generated independently of the records resulting from the ATM-based single message transactions. Advantageously, the subject invention allows for the integrity of the details of the processed transactions to be improved, in reporting to users, to minimize confusion and challenges of fraud.

These and other features of the invention will be better understood through a study of the follow detailed description and accompanying drawings.

### BRIEF DESCRIPTION OF THE DRAWINGS

FIG. 1 is a schematic of processing single message transactions over a payment network;

FIG. 2 is a schematic of a system usable with the subject invention; and,

FIGS. 3 and 4 are flow charts of method steps usable with the subject invention.

### DETAILED DESCRIPTION OF THE INVENTION

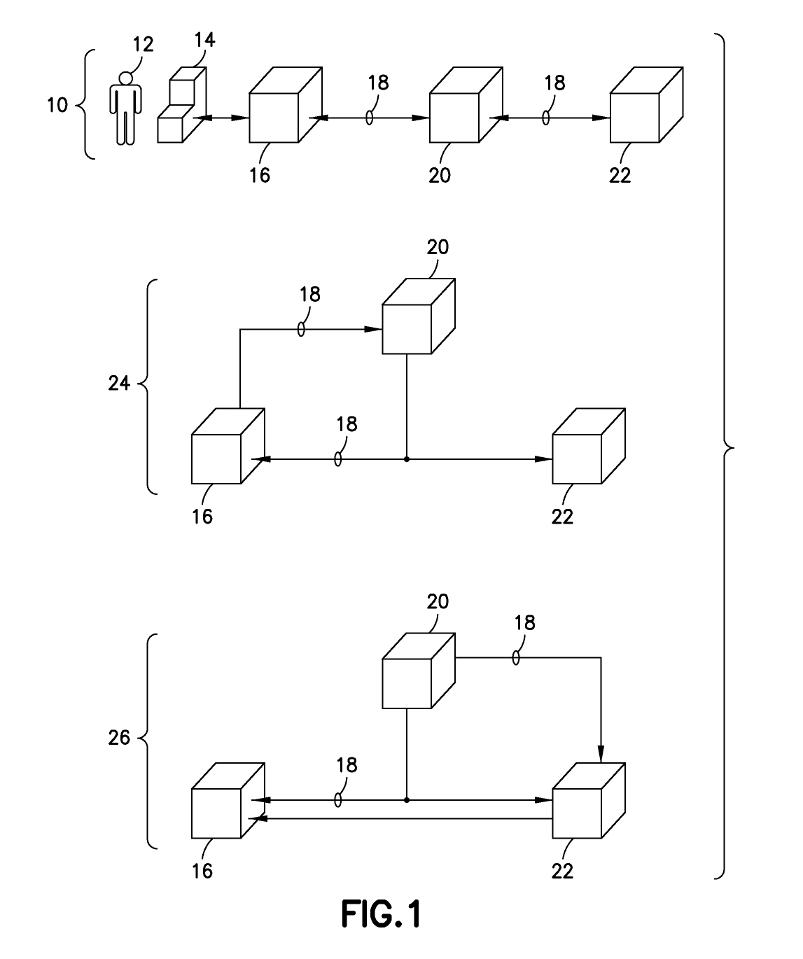

The subject invention is for use with ATM-based single message transactions processed over a payment network. With reference to FIG. 1, single message transactions are processed over a payment network in three generally simultaneous phases. With an authorization phase 10, a user 12 transmits an authorization request through an ATM 14 to withdraw a certain amount of cash. The ATM 14 may be owned and/or operated by a financial institution 16. Where the user is requesting withdrawal from an account not affiliated with the owner/operator financial institution 16, the owner/operator financial institution 16 may transmit the request onto a payment network 18, such as the MasterCard Debit Switch payment network, to obtain authorization from the user's financial institution for the withdrawal.

A payment network operator 20, such as MasterCard®, operates and maintains the payment network 18. The payment network operator 20 validates security features of the authorization request transmitted to the payment network 18 and, if in order, approves sending the authorization request to a financial institution 22 affiliated with the requested account of the user 12. The user's financial institution 22 may approve the authorization request or decline the authorization request depending on availability of the user's 12 funds or other criteria. The approval or decline is transmitted to the payment network operator 20 over the payment network 18, who in turn transmits the approval or decline to the owner/operator financial institution 16. With approval, the owner/operator financial institution 16 permits the dispensing of cash to the user 12 from the ATM 14. An amount may be dispensed up to the requested amount, subject to the transmitted approval of the user's financial institution 22. If the authorization request is denied by the user's financial institution 22, the denial is communicated by the ATM 14 to the user 12 and no cash is dispensed by the ATM 14.

Simultaneously with the authorization phase 10, a clearing phase 24 is performed wherein the owner/operator financial institution 16 sends details relating to the withdrawal transaction at the ATM 14 to the payment network operator 20 which validates the transmitted information and approves sending related details to the user's financial institution 22, which may be used in generating a statement for the user 12. The payment network operator 20 clears the transaction by providing reconciliation details to both the owner/operator financial institution 16 and the user's financial institution 22.

In a settlement phase 26, the payment network operator 20 calculates the net settlement position and sends advisements to both the owner/operator financial institution 16 and the user's financial institution 22 as to the details of the withdrawal transaction. Based on a transfer funds order generated by the payment network operator 20, money is transmitted from the user's financial institution 22 to the owner/operator financial institution 16 to cover the amount withdrawn from the ATM 14 plus any additional accrued fees. The money transfer may be conducted through an intermediary settlement bank or other financial institutions.

FIG. 1 represents schematically the processing of a single message transaction over the payment network 18. A single transmission from the ATM 14 is sufficient to initiate and complete the transaction.

The user 12 may conduct a transaction with the ATM 14 using any known configuration, including utilizing a readable card, such as with a readable magnetic strip, a NFC (near field communication) device, such as a fob or other wireles sly-communicating device which causes activation through proximity or other wireless communication to an ATM, and/or a manually-entered account or other identification number. Security measures, such as a pin, may be also employed.

The payment network 18 is a network of specialized computing devices which are operatively linked (hard-wired, wirelessly, etc.) to allow for secure transmission of transaction details between the various entities of the process to facilitate authorization, clearing and settlement of ATM-based single message transactions. The payment network 18 is restricted and not freely publicly accessible.

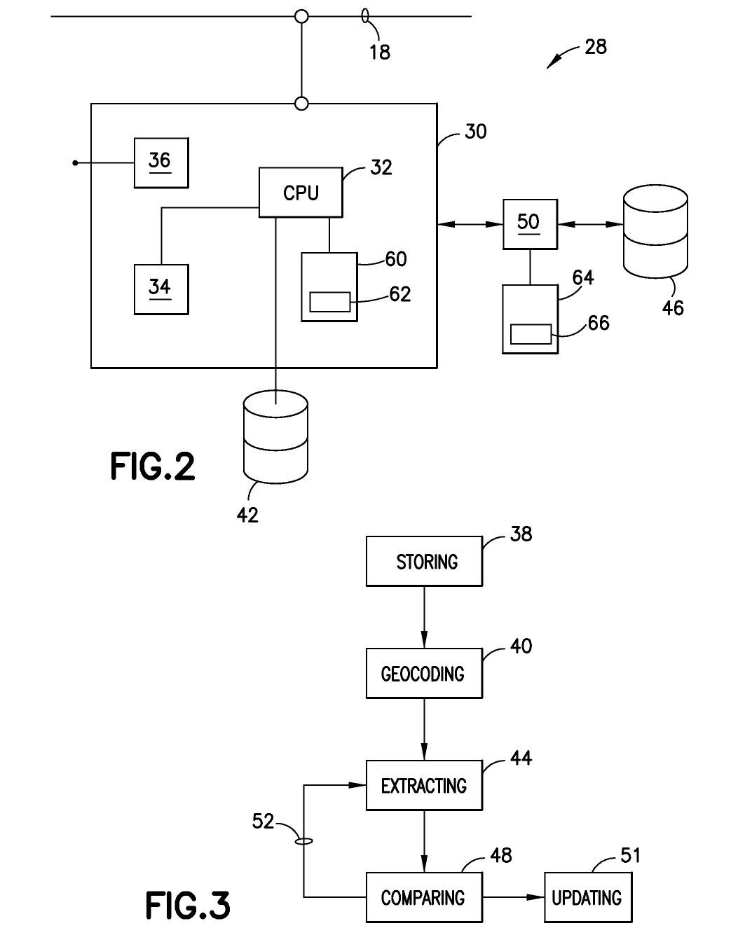

As set forth in FIG. 2, a system 28 is provided for improving the integrity of the location data of ATM-based single message transactions processed over the payment network 18. The system 28 generally includes at least one specialized computing device 30 on which records are electronically stored resulting from ATM-based single message transactions processed over the payment network 18. Other transactions, such as non-ATM-based and/or non-single-message transactions, may be processed over the payment network 18 along with the ATM-based single message transactions. The specialized computing device 30 includes a central processing unit (CPU) 32 linked with an electronic data storage 34 in which the records are electronically stored. The specialized computing device 30 may be operatively linked to the payment network 18 in any known manner, including being hard-wired or wirelessly connected, to identify ATM-based single message transactions processed over the payment network 18.

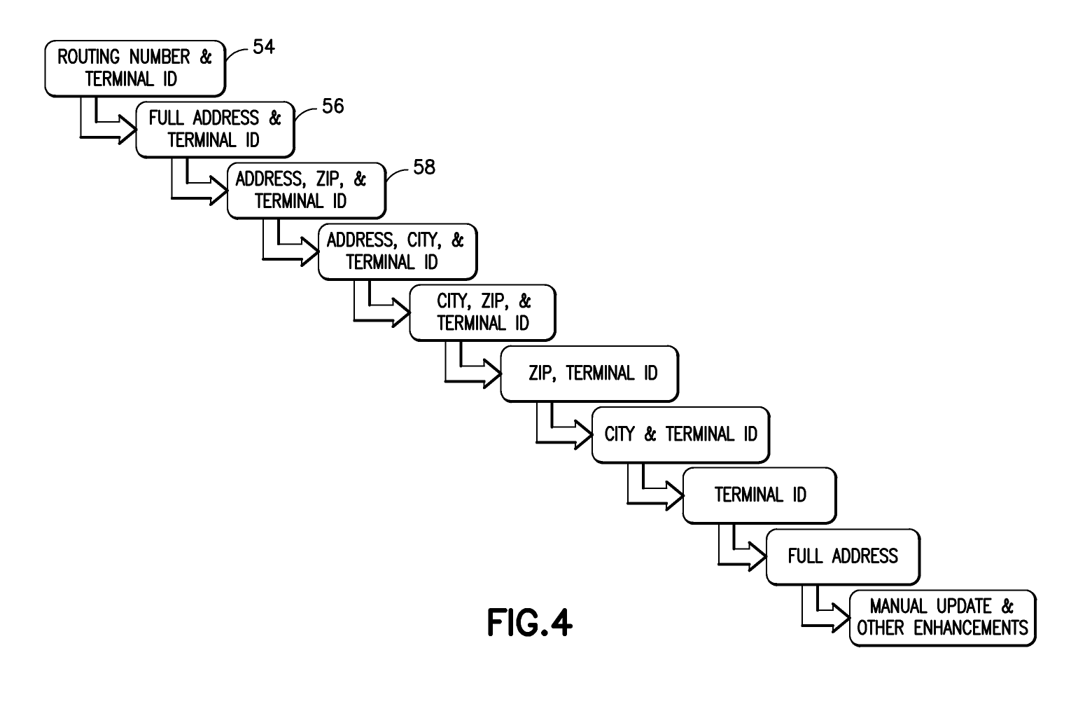

The specialized computing device 30 may be configured to recognize ATM-based single message transactions which have been authorized, cleared and settled on the payment network 18. Such transactions may be selected by the specialized computing device 30 post-settlement from the payment network 18 and electronically stored in the storage 34. In addition, or, alternatively, records of ATM-based single message transactions may be transmitted to the specialized computing device 30 via an interface 36, e.g., by bulk transmission, by the payment network operator 20, to store electronically in the storage 34. Transmission to the interface 36 may be via a connection outside of the payment network 18, e.g., via hard-wired and/or wireless connection with a network (global (Internet) or local). Alternatively, unsorted transactions may be transmitted to the specialized computing device 30 via the interface 36, e.g., by bulk transmission, with the specialized computing device 30 identifying the ATM-based single message transactions with those identified transactions being saved electronically in the storage 34. Ultimately, as shown in FIG. 3, records relating to ATM-based single message transactions are stored on the specialized computing device 30 (step 38).

The specialized computing device 30, including the CPU 32, the storage 34 and the interface 36, may reside on one computing device or more than one computing devices which are operatively linked.

As set forth in ISO 8583, information is communicated across the payment network 18 using standard message formatting. It is taken that the ATM-based single message transactions referenced herein are in standard message formatting. Authorization requests and other communications transmitted over the payment network 18 during the authorization, clearing and settlement phases may be consistent with this standard formatting. The various components of the payment network 18 are configured to process the standard message formatting.

With standard message formatting, particular data elements are included which relate to the transaction, including location data or an identifier of the associated ATM 14. The data elements are presented in a string format with particular character spaces, in fixed length or variable length, being designated to represent different details. ISO 8583 defines the format to string together the data elements for transmission and processing over the payment network 18. The location data of the associated ATM 14 may include a street address, city, state or other political division (e.g., province), country and zip code or other postal code. Data elements may also include a routing number for an associated transacting bank (e.g., the owner/operator financial institution 16, the user's financial institution 22), and a terminal identification member of the ATM 14.

The ATM-based single message transactions stored in the storage 34 may be geocoded by the specialized computing device 30 (step 40 in FIG. 3). In particular, the location data in the transactions may be geocoded, e.g., by the CPU 32. The geocoding allows for checking the location data in the data elements of the transactions to be checked against stored location data, e.g., location data stored in electronic geolocation database 42. The geolocation database 42 may be on-site with the CPU 32 or located remotely and accessed by a hard-wired or wireless connection, e.g., through a network.

The CPU 32 updates the transactions to include corrected information for the geocoding process to generate geocoded records which are stored electronically in the storage 34. The corrections may include correction in discrepancies, such as, for example, changing “Maple St.” to “Maple Ave.” based on city and zip code information. Other discrepancies may be likewise corrected. Any corrections may be made consistent with the standard message formatting (ISO 8583). As will be recognized by those skilled in the art, any geocoding technique may be utilized with the subject invention, such as software sold under the trademark “MapMarker” by Pitney Bowes, Inc.

The CPU 32 may be also configured to extract details from the geocoded records stored in the storage 34 (step 44 in FIG. 3). Preferably, the CPU 32 extracts at least two details from a given geocoded record. The details include those present in the data elements of the original ATM-based single message transactions subject to any corrections resulting from the geocoding process. The extracted details may include any of the following: routing member for an associated transacting bank (e.g., the owner/operator financial institution 16, the user's financial institution 22); a terminal identification member of the ATM 14; street address of the ATM 14; city of the ATM 14; state or other political division (e.g., province) of the ATM 14; country of the ATM 14; and zip code or other postal code of the ATM 14.

The details may be extracted by parsing with reliance on the standard message formatting (ISO 8583).

The extracted details may be compared with data structures maintained in a special purpose database 46 of ATM-related information generated independently of the ATM-based single message transactions (step 48 of FIG. 3). The special purpose database 46 includes data structures for maintaining the ATM-related information. Any form of computer database may be used for the special purpose database 46. The special purpose database 46 may reside on the specialized computing device 30 and/or on a computing device operatively linked to the specialized computing device 30.

The special purpose database 46 may include ATM-related information collected through various sources, including public sources and/or may be developed through independent self-reporting, e.g., by owners and/or operators of ATM's. The data within the special purpose database 46 preferably includes for various ATM's at least: routing member for an associated transacting bank (e.g., the owner/operator financial institution 16, the user's financial institution 22); a terminal identification member of the ATM 14; street address of the ATM 14; city of the ATM 14; state or other political division (e.g., province) of the ATM 14; country of the ATM 14; and zip code or other postal code of the ATM 14.

A special purpose database management system 50 may be provided to allow for comparing of the details extracted by the CPU 32 with the data structures of the special purpose database 46. The special purpose database management system 50 may include any of MySQL, MariaDB, PostgreSQL, SQLite, Microsoft SQL Server, Oracle, SAP HANA, dBASE, FoxPro, IBM DB2, LibreOffice Base, FileMaker Pro, Microsoft Access and InterSystems Caché.

The CPU 32 and the special purpose database management system 50 are configured to compare the extracted details and the data structures. The comparison seeks to identify data structures which individually contain wholly the extracted details. In other words, data structures are only identified which each include all of the extracted details.

Based on an identified data structure, details of the geocoded record may be updated (step 51 in FIG. 3) to track the full details of the identified data structure. It is taken that the data structure will include more accurate details as viewed as a complete record and compared with a corresponding geocoded record. Discrepancies between the identified data structure and the relevant geocoded record are reconciled by the CPU 32 by updating the geocoded records to match the details of the identified data structure and stored accordingly, e.g., on the storage 34. The updated geocoded records may be used by the payment network operator 20 to update records to better process data over the payment network 18 and/or may be transmitted to the user's financial institution 22 to include with reporting to the user.

To achieve a higher level of confidence of the identification of a data structure, the extracting of details and the comparing of the extracted details with the data structure may be conducted iteratively with various combinations of the details, as shown by process arrow 52 in FIG. 3. For example, and as shown in FIG. 4, in a first iteration 54, the routing number of an associated transacting bank and the terminal identification number of the ATM 14 may be extracted and compared with the data structures. This may result in a list of candidate data structures. In a second iteration 56, the street address of the ATM 14 and the terminal identification number of the ATM 14 are compared with the data structures. The resulting list of candidate data structures is compared against the first list of candidate data structures. If a significantly high enough level of confidence is achieved by the identification of a certain data structure, the process is complete. If not, a third iteration 58 is conducted and so forth ( . . . n iterations). FIG. 4 illustrates an iterative flow of combinations of details for comparing with the data structures. The process may be considered complete after any of the noted iterations.

In accordance with various embodiments of the present disclosure, the methods and system described herein are intended for operation as software programs running on a computer processor. Furthermore, software implementations can include, but are not limited to, distributed processing or component/object distributed processing, parallel processing, or virtual machine processing can also be constructed to implement the methods described herein.

The present embodiment contemplates at least one machine-readable medium or computer-readable medium 60 containing instructions 62, or that which receives and executes instructions 62 from a propagated signal, so that the CPU 32 may operate as described herein using the instructions 62. In addition, at least one machine-readable medium or computer readable medium 64 containing instructions 66, or that which receives instructions 66 from a propagated signal, so that the special purpose database management system 50 may operate as described herein using the instructions 66. The machine-readable medium or computer readable medium 60, 64 may be provided as one medium with the instructions 62, 66 located thereon.

While the machine-readable medium 60, 64 is shown in an example embodiment to be each a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform anyone or more the of the methodologies of the present embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives considered to be a distribution medium equivalent to a tangible storage medium. Accordingly, the embodiment is considered to include anyone or more of a tangible machine-readable medium or a tangible distribution medium, as listed herein and including art-recognized equivalents and successor media, in which the software implementations herein are stored.

Although the present specification describes components and functions implemented in the embodiments with reference to particular standards and protocols, the disclosed embodiments are not to limited to such standards and protocols.

What is claimed is:

1. A method of improving the integrity of location data in records resulting from ATM-based single message transactions processed over a payment network, said method comprising:
electronically storing records on a specialized computing device, the records resulting from ATM-based single message transactions processed over a payment network;
geocoding location data in the records to generate geocoded records which are electronically stored on the specialized computing device;
extracting at least two details from a first of the geocoded records; and
comparing, using a special purpose database management system, the at least two details with data structures maintained in a special purpose database of ATM-related information generated independently of the records resulting from the ATM-based single message transactions.

2. A method as in claim 1, wherein the at least two details include a routing member of an associated transacting bank and a terminal identification number of the associated ATM.

3. A method as in claim 2, further comprising, if the at least two details do not match with data contained wholly in at least one of the data structures, then, extracting for a second time, at least two details from the first of the geocoded records.

4. A method as in claim 3, wherein the second-extracted details include a street address of the associated ATM and the terminal identification number of the associated ATM.

5. A method as in claim 4, further comprising comparing, using the special purpose database management system, the second-extracted details with the data structures maintained in the special purpose database to determine if the second-extracted details match with the data contained wholly in at least one of the data structures.

6. A method as in claim 3, further comprising comparing, using the special purpose database management system, the second-extracted details with the data structures maintained in the special purpose database to determine if the second-extracted details match with the data contained wholly in at least one of the data structures.

7. A method as in claim 1, further comprising updating the first geocoded record based on at least one of the data structures identified by the special purpose database management system as matching with the first geocoded record.

8. A system for improving the integrity of location data in records resulting from ATM-based single message transactions processed over a payment network, the system comprising:
electronic data storage for storing electronically geocoded records of ATM-based single message transactions processed over a payment network;
central processing unit;
non-transitory, machine-recordable storage medium, storing thereon a first program of instructions which, when executed by the central processing unit, cause the central processing unit to
extract at least two details from a first of the geocoded records;
database management system; and
non-transitory, machine-readable storage medium, storing thereon a second program of instructions which, when executed by the database management system, cause the database management system to
compare the at least two extracted details with data structures maintained in a database of ATM-related information.

9. A system as in claim 8, wherein the first program of instructions further includes instructions which, when executed by the central processing unit, cause the central processing unit to
geocode location data in ATM-based single message transactions processed over a payment network to generate the geocoded records for storing on the electronic data storage.

10. A system as in claim 8, wherein the first and second programs of instructions are located on the same non-transitory, machine-recordable storage medium.

11. A system as is claim 8, wherein the central processing unit and the database management system extract and compare the details, respectively, in iterations.
